(19) United States
(12) Patent Application Publication
(10) Pub. No.: US 2023/0405925 A1
(43) Pub. Date: Dec. 21, 2023

(54) FAST LAYERED EXTRUSION FOR ADDITIVE MANUFACTURING

(71) Applicant: Saudi Arabian Oil Company, Dhahran (SA)

(72) Inventor: Brian PARROTT, Dhahran (SA)

(73) Assignee: Saudi Arabian Oil Company, Dhahran (SA)

(21) Appl. No.: 18/461,669

(22) Filed: Sep. 6, 2023

Related U.S. Application Data
(63) Continuation of application No. 17/443,808, filed on Jul. 27, 2021.

(51) Int. Cl. B29C 64/209; B33Y 10/00; B33Y 30/00; B29C 64/118; B29C 64/218; B28B 1/00

(52) U.S. Cl. CPC B29C 64/209; B33Y 10/00; B33Y 30/00; B29C 64/118; B29C 64/218; B28B 1/001; B29K 2105/08

(57) ABSTRACT

An apparatus for three-dimensional (3D) printing of an object comprises a print head having at least one inlet for receiving material to be extruded and an outlet. The print head is configured, when the outlet is completely unblocked, to extrude a sheet of material of the width and height of the outlet. One or more actuators are positioned along the width of the print head and arranged to controllably block one or more sections along the width to prevent material from being extruded through the blocked sections, enabling selective extrusion of material through sections that are not blocked in order to selectively print a width of an entire layer of the object in a single pass. The print head and the object move relative to one another via one motion of the print head or of the object.

### FIELD OF THE DISCLOSURE

The present disclosure relates to additive manufacturing and three-dimensional (3D) printing, and more particularly relates to a method and apparatus for fast layered extrusion for additive manufacturing.

### BACKGROUND OF THE DISCLOSURE

### Nozzle-Based Deposition

There are a number of additive manufacturing technologies currently available in the market. Nozzle-based deposition, which generally employs fused filament fabrication (FFF), is used by most consumer-grade 3D printers. In this group of techniques, filaments of thermoplastic are pushed through a heated nozzle (extruder), creating a very thin filament that bonds to the surface it is placed on. In many systems the nozzle can move in three dimensions relative to the working surface and a 3D model is built up dot-by-dot in a continuous stream of layered thermoplastic. Some other materials can be mixed in with the thermoplastic, but the functionality typically remains the same. In some implementations of this technique pellets can be used rather than filaments to feed the extruder to reduce costs.

Nozzle-based deposition can generate strong objects, particularly in thick sections and in regions at which layer boundaries are not stressed. This technique also has the advantage that is relatively inexpensive and ubiquitous, benefitting from many years of development by both commercial and other developers. Nozzle-based systems typically do not require enclosures or a highly-controlled environment for operation. On the other hand, there are some weakness associated with nozzle-based techniques. The filament deposition process is slow. Certain structural features, such as overhangs, are difficult to build without supports, resulting in slower build time and design constraints. Furthermore, plastic filaments, which are the material employed in most nozzle-based systems are more expensive than the raw materials in pellet form. Additionally, warping due to heat can be a challenge, especially in uncontrolled environments or in the production of large 3D objects where internal stresses can build up as the temperature varies across the part during construction.

### Liquid Spray Deposition

Liquid drip or spray deposition is another 3D printing technology that uses a similar movement and build strategy as nozzle-based deposition, but instead of using heat-softened thermoplastics it deposits materials in liquid form. The liquids can be expelled via drips, sprays, syringes, pneumatically actuated tanks, etc. and can include materials ranging from cell cultures to heated chocolate. Generally speaking, these systems tend to be for relatively specialized use cases in either the food or medical industries, though they are also used in electronics fabrication to place conductive inks or solder paste in automated PCB assembly lines. Due to the liquid nature of the extrusion, these types of printers are generally less accurate relative to their speed and are not used in large-format additive manufacturing. Liquid spray printing technologies have the advantage of providing for the printing of materials otherwise not possible with nozzle-based and fused filament fabrication and thermal management is not stringent. The disadvantages of the liquid spray-based techniques are that they are not suitable for building solid objects with high strength, the materials are often slow to solidify or delicate, and the spray-based printing process may require additional step(s) to solidify, dry or otherwise finalize production.

### Resin Bath Curing

Resin Bath curing is another form of additive manufacturing in which resin in a bath is cured using light (generally ultraviolet (UV) radiation). Generally speaking, a build surface is mounted face down into the bath of resin and light is projected onto it, solidifying the layer of resin at the surface of the build platform, which then rises up, allowing a new layer of resin to move into the vacated space. Resin bath technology can utilize a scanning laser, or a full projector that projects a two-dimensional image in order to cure layers quickly and build highly accurate models at a fast rate. These optical development methods that project light onto and cure an entire layer at a time can print at a very high resolution with extremely high speeds. Since curing is non-binary, layers can be partially cured across multiple steps to promote inter-layer bonding. The drawbacks of radiation-cured printing are that photo-reactive resins tend to be more brittle than thermoplastics or thermosets resulting in less resilient models. The resins are also often susceptible to UV-based warpage, thus making them unsuitable for most outdoor uses. The need for a bath of resin also makes this technique less viable in larger formats. Additionally, photo-reactive resins are costly and require careful handling.

### Resin Jet Printing

Resin Jet Printing is a related technique that basically combines inkjet printing with photoreactive resins in order to build models layer by layer. This technology utilizes print heads to spray liquid resin with high accuracy and uses photocuring radiation such as via a UV lamp to cure the resin partially with each pass, allowing the parts to be built up as if they were printed out of ink, layer by layer. Support materials, such as wax, are generally used to support overhangs or curves, and excellent speed and resolution can be obtained. Unlike resin bath printing, multiple materials can be deposited in each pass, thus allowing for more complicated materials or mixtures of resins with unique properties. Resin Jet Printing provides a relatively fast method of printing high resolution parts. As layers are only partially cured with each pass, inter-layer bonding problems are lessened. This technology enables multi-material, multi-color 3D printing, with some implementations enabling RGB printing through the combination of three or more differently colored materials. However, as in the case of the Resin bath technique, photoactive resins such as UV-cured resins tend to be brittle, resulting in less resilient models. The resins are also often susceptible to UV-based warpage and are unsuitable for most outdoor uses. Wax supports tend to be required for building, resulting in additional post-processing of parts.

### Binder Jet Printing

Binder jet printing is another technique based upon an inkjet mechanism but utilizes a binder rather than an ink. The binder is selectively sprayed upon a bed of build material (usually sand or other small particulate) and then the entire bed drops down, as new build material is carefully drawn across the surface to create a new level, and the process repeats. Two common uses of this technology are to make ‘sandstone’ RGB-colored models as well as to bind metal powders which are then sintered in a furnace. This technology can also be used with engineering plastics and many other material types. Binder jet print provides for relatively fast build-up of objects as a high amount of binder can be expelled relatively accurately and many different materials can be used for building, including metals. Colors can easily be incorporated into the printing process to enable full-color objects to be directly printed. The raw materials are typically less expensive than those used in other additive manufacturing processes (e.g. metal powder used in this technology is similar to what is used for casting or other processes, with minimal additional processing, making the technology more cost-effective). An important drawback of binder jet print is the relatively poor resolution that results when it is used to build large items thick layers, as the binder tends to bleed through the grains of material creating rough edges. In binder jet printing the strength of the objects built are dependent upon the strength of the binder unless they are post processed (e.g. metal powder sintered in a furnace). Furthermore, the binder jet technique requires a complicated bed setup to prepare each layer for binder, thus limiting uses outside of a workshop/factory environment and creating challenges in scale-up, especially in the vertical direction. Powder that is not used in a print needs to be cleaned and prepared for reuse, resulting in some waste, and the need for environmental controls.

### Laser Sintering

Laser sintering is a direct build method similar to binder jet printing, but instead of spraying binder, the system directly sinters particles with a laser. While this technique can be used with a variety of materials (plastic, sand, metal), the most common application is metal, as laser sintering is a direct method for manufacturing parts out of metal. Laser sintering systems can be open to the air but more typically operate in an inert gas environment to minimize issues with oxidation and improve object properties. Each layer is sintered before the bed drops and a new layer of powder pulled across the top to prepare for the next layer to be sintered. Generally, a single laser dot is used and moved across the bed at a high rate using mirrors to guide the beam. Final parts may undergo heat treatment to relieve any internal stresses, but they do not need to be sintered in a furnace. Other post processing to achieve dimensional accuracy and surface finishes may be used with this technique. Laser sintering offers the ability to directly manufacture metal parts with high strength. Additionally, laser sintering processes are relatively fast even though a single “bead” is used. Resolution is difficult to maintain in the sintering process at higher speeds due to warpage of the powder as the sintering process occurs. The surface tension between sintering beads of the metal powder tends to cause the material to draw together within the entire region that is currently being heated, thus creating a tradeoff between bead size/speed and resolution.

### Cut Sheet Layering and Tape-Base Manufacturing

Cut sheet layering and Tape-base manufacturing are forms of additive manufacturing in which layers of paper (or other materials) are cut out layer by layer and then stacked (and usually glued) together to form an object layer by layer. These techniques provide the manufacturer multiple materials options (paper, plastic, CFRP, metal, etc.) and resolution can be high, depending on the technology used to cut or lay the layers. Cut sheet layering can be rapid when moderately thick sheets can be quickly cut, stacked, and bound. However, this technique is wasteful because significant portions of each sheet are cut and, at best, recycled into a new sheet. In addition, the layers must be bonded together, whether by heat treatment, binders, or other means of attachment.

### SUMMARY OF THE DISCLOSURE

In one aspect, the present disclosure provides an apparatus for three-dimensional (3D) printing of an object. The apparatus comprises a print head having at least one inlet for receiving material to be extruded, an outlet having a width and height, the print head being configured, when the outlet is completely unblocked, to extrude a sheet of material of the width and height of the outlet and one or more actuators positioned along the width of the print head and arranged to controllably block one or more sections along the width of the outlet in such a manner as to prevent material from being extruded through the blocked one or more sections, thus enabling selective extrusion of material through a remainder of sections of the outlet that are not blocked in order to selectively print a width of an entire layer of the object in a single pass. The apparatus further includes a mount on which the print head is supported. The print head and the object move relative to one another via either the print head moving via the mount relative to the object or the object moving on a platform relative to the mount.

In another aspect, the present disclosure provides a method of additively printing layers of material to form a three-dimensional object using a print head having one or more inlets and an extrusion outlet having a width and a height. The method comprising providing material to the inlets of the print head, extruding the material across the entire width of the outlet, controllably moving a set of linearly distributed actuators to selectively block material flow across the width of the outlet, wherein selective blocking of the material flow by the actuators prevents or permits flow of material in selective regions of the outlet in order to extrude a layer of material with a desired pattern, and moving the print head relative to the object or the object relative to the print head in a direction intersecting a normal of the direction of extrusion from the outlet and parallel with a surface upon which the layer is being extruded.

These and other aspects, features, and advantages can be appreciated from the following description of certain embodiments of the disclosure and the accompanying drawing figures and claims.

### BRIEF DESCRIPTION OF THE DRAWINGS

FIG. 1A is a schematic illustration of the 3 degrees of movement (3^{rd} order problem) of 3D-printing using a single bead in the nozzle-based systems of the related art.

FIG. 1B is a schematic illustration of the linear extrusion method according to the present disclosure indicting how the 3^{rd} order problem illustrate in FIG. 1A is converted into 2^{nd} order problem.

FIGS. 2A-2D are schematic illustrations of different actuator configurations for a linear extrusion print head according to the present disclosure depicting intra-layer height resolution.

FIG. 3A is a schematic illustration of a linear extrusion print head with teeth actuators positioned near the extrusion outlet according to an embodiment according to the present disclosure.

FIG. 3B is a schematic illustration of a teeth actuators positioned upstream away from the extrusion outlet according to another embodiment of a linear extrusion print head according to the present disclosure.

FIGS. 4A-4E illustrate different embodiments of teeth actuators having different end shapes according to the present disclosure.

FIGS. 4F-4J show illustrations of complex teeth having one or more sub-shapes according to embodiments of the present disclosure.

FIGS. 5A and 5B schematically illustrate lip-based actuator mechanisms for extrusion control with double-actuation according to the present disclosure.

FIG. 6 is a schematic illustration of a linear extrusion print head according to an embodiment of the present disclosure having variable actuator sizes applied to printing a wall.

FIG. 7 is a schematic illustration of an example printing operation in which a linear extrusion print head extrudes material to span a gap between two cooled and solidified objects according to an implementation of the print head of the present disclosure.

FIG. 8 is a schematic illustration of use of a support flap used to promote inter-layer compression according to an embodiment of the present disclosure.

FIG. 9 is a schematic illustration of the use of a transfer roller with a linear extrusion print head according to an embodiment of the present disclosure.

FIG. 10 is a schematic plan view that illustrates of a rotational print head movement system according to an embodiment of the present disclosure.

FIG. 11 is a schematic illustration showing an exemplary linear extrusion print head according to the present disclosure mounted on a carriage over build area.

FIG. 12 is a schematic illustration of an exemplary embodiment a delta-based control arrangement according to the present disclosure.

FIG. 13 is a schematic illustration of a robotic arm for mounting and moving a linear extrusion print head according to the present disclosure.

FIG. 14 is a schematic illustration showing rotational printing using a linear extrusion print head according to the present disclosure in which a tire is printed layer-by-layer.

### DETAILED DESCRIPTION OF CERTAIN EMBODIMENTS OF THE DISCLOSURE

As discussed above, the main challenge with the nozzle-based deposition of thermoplastics is that it is a relatively slow process. While some embodiments have used larger nozzles to overcome this to some degree, such attempts to improve throughput only have a linear improvement on the overall print speed while sacrificing accuracy. Other systems have proposed the use of multiple print heads, usually for the purpose of extruding multiple materials (e.g. dissolvable support materials to support the model materials as they are printed), but occasionally envisioning increased speed. While there is a linear increase in potential speed for each new print head added, the addition of additional print heads increases the system complexity and does not change the order of the problem. Since all of these technologies extrude what is essentially a line of material, one can envision a discrete ‘voxel’ (a volumetric, 3-dimensional ‘pixel’) which can be printed by such systems in a specific amount of time. In a typical example, a desktop 3D printer extrudes through a 0.4 mm head and extrudes layer heights at least 1.2 times lower than the head height (e.g., a 0.3 mm layer height). If the print head travels at linear speeds of approximately of and prints voxels of size 0.4 mm in the x and y axis and 0.3 in the z-axis (layer height), the 3D printer can print no more than 125 voxels per second assuming perfect efficiency. This amounts to a maximum volume of 6 mm³/second. As such, even assuming perfect extrusion efficiency, it would take about 2 days to print a solid 10 cm cube.

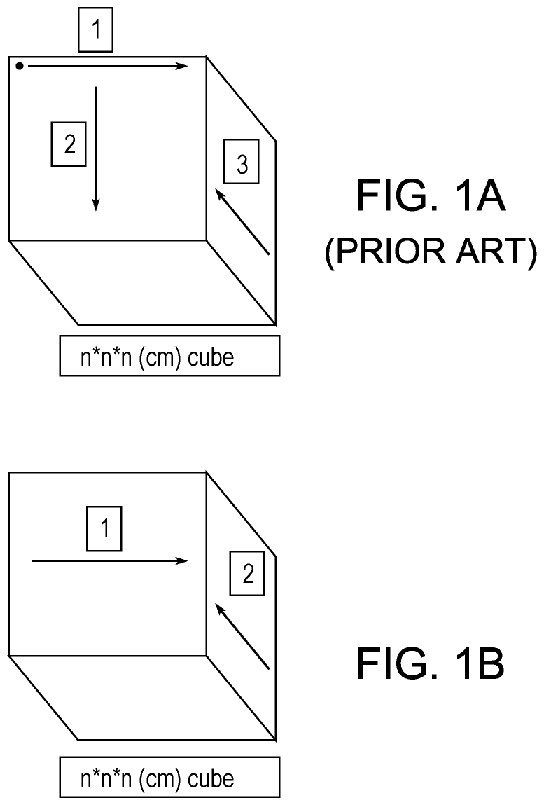

FIG. 1A is a schematic diagram of a printing scheme illustrating how 3D printing using beads of material is a 3^{rd} order problem. As the head of the 3D printer can only print a single voxel at a time it moves in three dimensions to complete a 3-dimensional print. In FIG. 1B, the direction that the print head moves is defined as the x-axis, the length along the print head is defined as the y-axis, and the z-axis defines the height of the building space.

The system and methods disclosed herein converts this problem into a 2^{nd} order problem by printing an entire line at a time. The difference is illustrated in FIG. 1B which illustrates how three directional movements are cut down to two, providing a dramatic increase in speed and throughput. Using the previous exemplary layer height of 0.3 mm, and half the exemplary travel speed (25 mm/second), a 100 mm wide system can extrude 750 mm³/second compared to the example rate of approximately 6 mm³/second. The 10 cm cube that would take 2 days according to the related art takes only 22 minutes using this disclosed system and method, representing an increase in speed of 2 orders of magnitude as the task complexity shifts from the third order to the second. In particular, objects that are encompassed within the width of the extrusion head and have a large footprint can be printed especially quickly, for example, making this technology well suited for large area 3D printing, such as for the fabrication of automobile chassis, boat hulls, propeller blades, furniture and even whole homes.

The disclosed linear extrusion print head system is capable of printing both thicker layers and even multiple layers in a single pass. While a standard extrusion system is limited to relatively small layer heights in order to ensure good interlayer binding, the proposed system and method reduces interlayer binding difficulties since the time between successive layers is lower and various strategies can be employed to improve the interlayer binding at a layer-level. In some implementations, a linear extrusion print head can print layers of 1 mm thickness (total width) and still maintain a voxel height of 0.3 mm in most cases by using only two actuators with multiple control steps.

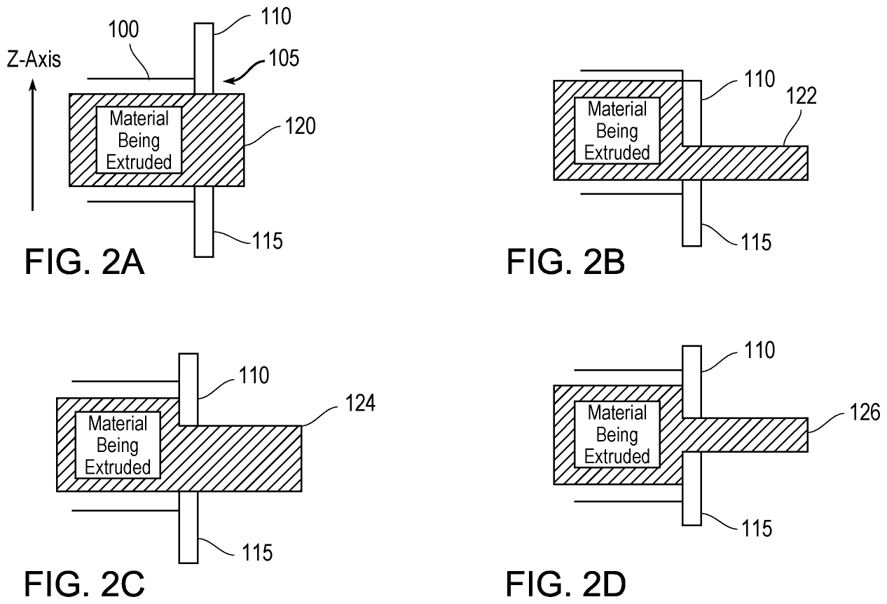

FIGS. 2A-2D are schematic illustrations of different actuator configurations for a linear extrusion print head according to the present disclosure depicting intra-layer height resolution. FIG. 2A shows a print head 100 with an extrusion outlet 105 and actuators 110, 115 which can move in the directions indicated by the arrows to controllably open or close the sections of the extrusion outlet 105. In FIG. 2A, actuators are shown in “end” positions and the extrusion outlet 105 is fully open. In the fully open position, the width of the extruded material 120 contains three “intra-layers”. In FIG. 2B, actuator 110 is moved to a position toward the other actuator 115, which in this implementation remains in the same position as in FIG. 2A. It is understood that the movement of the actuators is described in terms of relative movement towards or away from each other to avoid terms such as top, bottom up and down since the print head can be oriented in various ways. In this position, actuator 110 blocks a portion of the extrusion outlet 105, and the extruded material 122 contains only a single intra-layer (in terms of height or width) located toward a first end of the extrusion outlet. In FIG. 2C, actuator 110 is moved to a position further away from actuator 115. In this position, the actuator 110 blocks a smaller portion of the extrusion outlet in comparison to FIG. 2B, and the extruded material 124 contains two intra-layers. Finally, in FIG. 2D, both actuators 110, 115 are moved toward each other to block portions of the extrusion outlet 105. In this position, the actuators 110, 115 block two-thirds of the extrusion outlet 115 so that the extruded material 126 comprises a single intra-layer located toward the middle of the extrusion outlet 105. It should be understood that this is an exemplary description of intra-layer printing, and that this technique is not limited to using only 3 intra-layers, nor is it fully dependent on using actuators on both sides of the print head.

Using continuous motion control, enhanced z-axis resolution of these layers can be achieved. Thus, the ability to print taller layers can dramatically increase the speed of 3D printing using the proposed technology while sacrificing very little in terms of resolution. For example, if a layer height of 1 mm is extruded rather than the 0.3 mm layer at 100 mm width with a print speed of 25 mm/second, 100 mm width, the volume output increases to 2500 mm³ (as opposed to 750 mm³). In this implementation, a 10 cm cube can be produced in 100 passes, each taking 4 seconds, resulting in a print time of just under 7 minutes compared to the less optimized system speed of 22 minutes, or the current bead-deposition technology speed, noted above, of 2 days.

The actuators of the extrusion print head 100 can be implemented with different types of actuator components that can be activated to enable selective control of where the material is extruded from the outlet. Programmable control of the motion of the actuators allows a user to create an object by converting a digital model into a set of computer-executable instructions that the machine can use to extrude material through the actuated print head only where it is needed for the model. As discussed above, this enables much faster 3D printing, especially of larger items, densely filled items, and as the sheet extrusion head becomes wider and taller.

In one embodiment, the actuators for selectively opening and closing sections of the extrusion outlet of the print head are configured as teeth-shaped elements, as were shown in FIGS. 2A-2D that slide across the extrusion outlet in the vertical direction in order to open and close a section of the extrusion head. The teeth, which are generally rectangularly-shaped elements, can be positioned at either the top or bottom of the extrusion head, or on both top and bottom (as shown in FIGS. 2A-2D). Double actuator control from upper and lower sides is a preferred embodiment as it provides for greater control and the ability to use larger layer heights without sacrificing vertical (z-axis) resolution. In some embodiments, however, it can be advantageous to position the teeth actuators on one side in order to maximize horizontal (x-axis) resolution since there can be some tradeoff between the z-axis resolution achieved through double actuation versus the x-axis resolution achieved through single-sided actuation, which is typically less complex for a given resolution in the x-axis. Additionally, depending on the material properties and actuation of the print head itself, placing the teeth on both sides may interfere with the close placement of the print head to the layer below, thus some embodiments may benefit from the simplicity of a single-sided actuation.

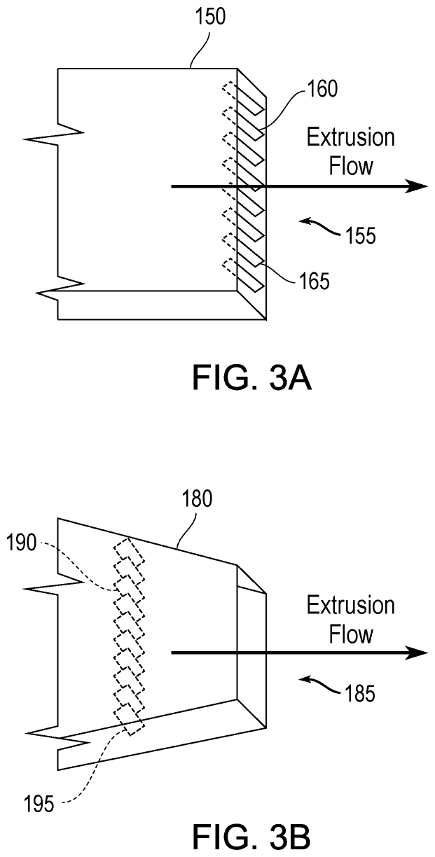

In addition to the placement of the teeth within the print head, the teeth can also be placed further back in the system upstream of the print head. While placing the teeth at the print head typically provides finer control of the output right before placement, careful design and modeling can enable larger teeth to be placed further back in the material flow path. In such embodiments, this enables material to be extruded at the end of the print head when needed. FIG. 3A is a schematic illustration of a print head 150 with tooth actuators e.g., 160, 165 located near the extrusion outlet 155. FIG. 3B is a schematic illustration of a print head 180 with tooth actuators e.g., 190, 195 positioned upstream away from the extrusion outlet 185. Typically, that actuators can be positioned 1 to 5 times the height of the opening of the extrusion outlet with some variability depending on the material used. The teeth 190, 195 can be comparatively larger in size than those used in the embodiment illustrated in FIG. 3A for a given extrusion resolution. There is more flexibility as to the shape of the extrusion outlet 185 in the embodiment shown in FIG. 3B and the outlet can be shaped in different ways depending on the desired performance and modelling optimization to extrude the same structures otherwise delivered from the system shown in FIG. 3A. Positioning the actuators upstream can provide additional flexibility in design. For example, the teeth can be configured to move along the z-axis from top to bottom, allowing for a single actuator to control flow from either the top or the bottom, or even with a specific type of extrusion outlets.

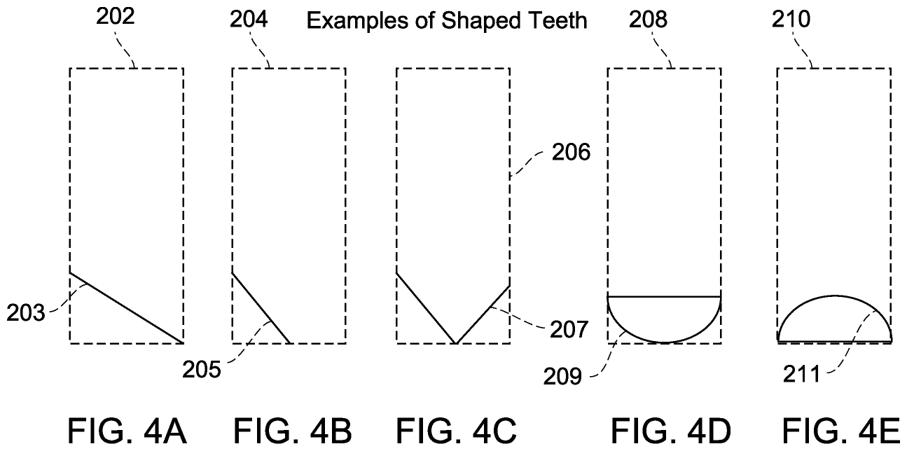

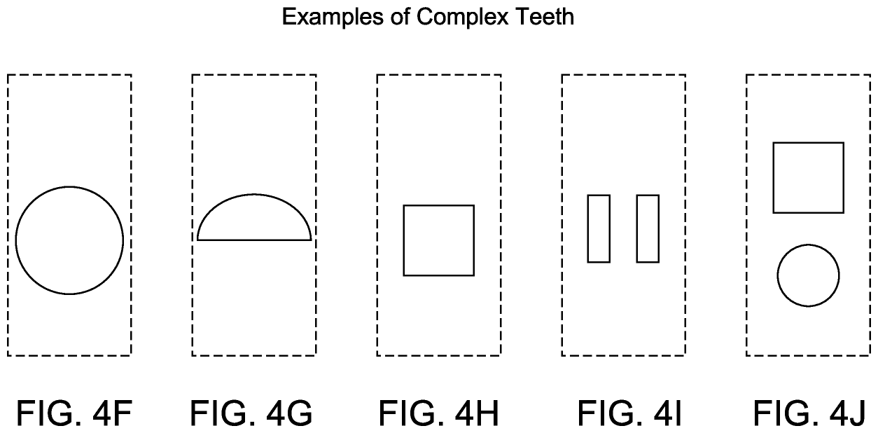

The teeth can have various end shapes to affect the extrusion flow. FIGS. 4A-4E illustrate different embodiments of tooth element having different end shapes. In FIG. 4A, a tooth element 202 has a diagonal knife edge 203 running across the full width of the tooth element. FIG. 4B shows another tooth element 204 having a sharper but narrow diagonal edge 205 that runs from one side to approximately a midpoint end face of the tooth. FIG. 4C shows another embodiment in which the tooth 206 has a triangular edge 207. In FIG. 4D the end face of the tooth 208 is a convex element 209, while in FIG. 4D the end face is a concave element 210. Using computer software, an optimized arrangement of shaped teeth can be selected from a predefined group of options adapted to enable the fastest, most accurate build time for a given project while achieving the closest match to the intended design. Alternatively, specific shapes could be enabled as part of the design process without sacrificing voxel size, thus enabling sub-voxel-size resolution of the item being manufactured.

As noted, in some implementations, the teeth can be designed to either fully close by extending beyond the end of the print head outlet or to overlap each other when actuated from both sides to fully block the flow of material in areas where a cavity was desired. In certain embodiments, complex teeth having one or more shapes can be employed. At certain positions, a given tooth can have a specific sub-shape thus functioning as a small extrusion die inside of the larger print head. By using a system that moves the teeth fully across the print head, the sub-shapes could then be printed in an intra-layer fashion in order to achieve high-resolution, fast additive manufacturing at a larger scale. FIGS. 4F-4J show illustrations of complex teeth having one or more sub-shapes.

Furthermore, the teeth actuators can be interchangeable and different print heads can be used for different applications. For example, a home construction printing system can use different print heads for walls, ceilings, floors, for columns or beams, windows, etc. These heads can be interchangeable via an automated changing station such that the same extrusion system could be used for all of these applications. Alternatively, multiple extrusion systems can also share heads in an intelligent and coordinated manner. The teeth can also be individually changeable in a similarly automated fashion if, for example, specific teeth are suited for specific sections of the project. Such teeth can be customized for specific project or industry application. Alternatively, other embodiments multiple systems with different non-interchangeable print heads can be used in coordination.

In another embodiment, the elements used to selectively block the extrusion outlet can be configured as flexible sleeves having edges or “lips” that determine the size of the openings of the extrusion head. The flexible sleeves can be made a metal, a high-temperature polymer, or another material that is flexible, low friction, and is able to retain its structural integrity at temperatures greater than those used to extrude the build material. The flexible sleeve material can also be selected to have sufficient elasticity to enable various configurations without creating significant stress on the material. For example, the material can be reinforced using fibers along a specific axis (e.g., the direction of flow) to add strength to a flexible composite. The lips can also be implemented using mechanical mechanisms, such as sheets of metal that slide across one another to permit expansion and contraction within the constrained volume made by the teeth.

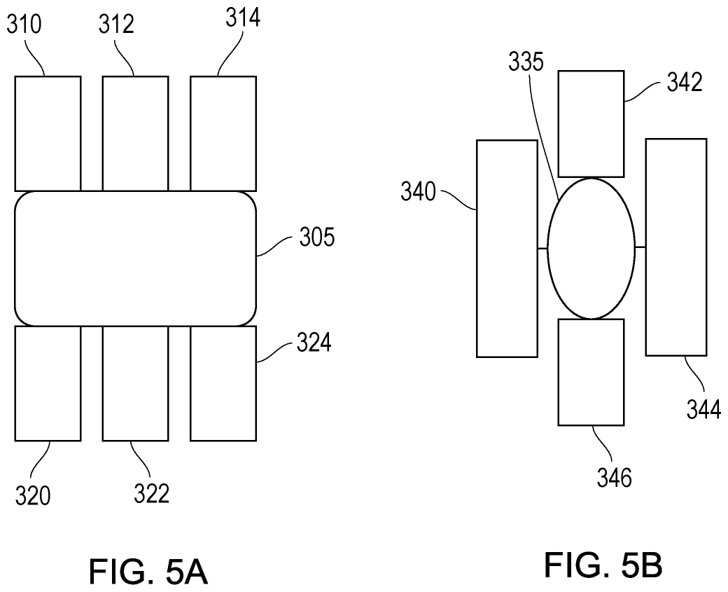

FIGS. 5A and 5B schematically illustrate lip-based actuator mechanisms for extrusion control with double-actuation. In FIG. 5A, a generally rectangular extrusion outlet 305 is shown having upper and lower sides. Three lip elements 310, 312, 314 are arranged at the upper side of the outlet and another opposing three lip elements 320, 322, 324 are arranged at the lower side of the outlet. Lip elements 310, 312, 314 are controllable to pull upward or push downward on the edges of the extrusion outlet 305. Likewise, lip elements 320, 322, 324 are controllable to pull downward or push upward on edges of the outlet. The dual sets of actuators on the upper and lower sides work in tandem to set the extrusion flow from the extrusion outlet. In other implementations, the lip elements can be positioned on only one side of the opening 305.

In FIG. 5B, a generally elliptical-shaped extrusion outlet 335 is shown. Lip elements 340, 342, 344, 346 are positioned, respectively, above, below, to the left and right of the outlet. Each of the lip elements 340-346 can be actuated to pull on edges of the extrusion outlet. In the implementation shown in FIG. 4B, lip elements are positioned in the four cardinal directions around the extrusion outlet. In other implementations, fewer lips or a greater number of lip elements can be used.

Solenoids or piezoelectric transducers are coupled to the lips in such manner to that they can both push the lips closed and pull the lips open. In another implementation, the actuators can apply only compression forces and rely upon the extrusion pressure to reopen the lips when the compression pressure is removed. The use of lips to control the flow allows for more complex curvatures and organic shapes that can be difficult to accomplish with rectangularly shaped teeth.

An important aspect of the linear extrusion systems and methods disclosed herein is that they provide significant control while extruding large volumes, not only in the x and y-axes but also in the z-axis, along the height of each layer extruded. In some embodiments, discrete, or binary control of the actuators is employed in which the actuators are selectively positioned in either an open or closed position. This control implementation enables a fast, easy control of hundreds or even thousands of actuators. In another embodiment, continuous actuator control (or multiple step actuator control) is implemented. In this embodiment, the magnitude of the actuator is not binary, allowing for much finer control at the cost of greater system complexity. One of the main benefits of continuous control is enhanced speed without sacrificing resolution. With continuous control of actuator placement, the height and placement of each voxel in the z-axis in each layer can be determined. As shown above, FIG. 2A illustrates how three layers can be printed in a single pass (i.e., one layer with the resolution otherwise achievable only through three layers of ⅓ thickness using discrete actuation). Additionally, continuous control provides numerous intralayer structuring opportunities, enabling a cheap, resource efficient manufacture of very complex structures with internal voids, multiple materials, conduits, etc.

It is noted that the actuators for opening and blocking sections of the extrusion head, such as teeth elements, can be either evenly or unevenly spaced, and the elements can be of varying size. Extrusion heads can include unactuated sections (always open or always closed). In many embodiments, the entire sheet width of the print head includes actuated controls. However, there is a trade-off in that an entire span of actuators can require numerous (e.g., hundreds) of controller elements and linked drive mechanisms, particularly in the case of high resolution printing. The benefit of actuators of different spacings and sizes is it can be tailored for the required resolution. The target print resolution for some sections of a build can be higher or lower than others and having higher resolution actuation may not be necessary for some sections. For example, if the built object is a car chassis, the chassis design typically has certain sections that require only low resolution (e.g. support beam like structures) while other sections that require much higher detail (e.g. the edges where the chassis may curve or have complex features.) For this application, if all of the actuators are set to the same size, in the control algorithm numerous actuators are set together with the same instructions. This enables a simpler control scheme to be implemented. For example, a print head with fewer actuators can be employed, and the control program can be configured to detect (through hardware or software communication, RFID tags, etc.) the print head actuator arrangement. The control program can then adjust the actuation to correspond to the print head. The arrangement of the actuators and/or sizing of the print head can be recommended by the software program based on a variety of characteristics, such as simplicity, speed, accuracy, etc. that would allow a user to select an optimal arrangement for a given print job. In another example, a print head used for building structure walls can have higher actuator resolutions in the outer areas or in specific internal areas where conduits might be placed, while having much lower actuator resolution in the y-axis in other locations.

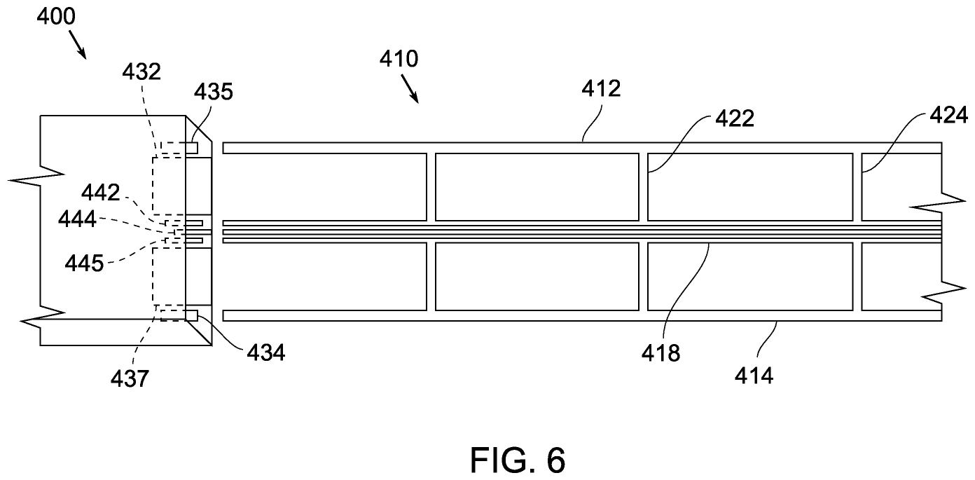

FIG. 6 is a schematic illustration of a linear extrusion print head 400 according to an embodiment of the present disclosure having variable actuator (teeth) sizes applied in printing a wall. In this illustration, the printer is building out a wall 410. The wall includes exterior sections 412, 414 and a central conduit 418. Evenly spaced supports e.g., 422, 424 are aligned in the y-axis. The corresponding tooth actuators are sized and spaced for this application. Print head 400 includes end actuators 432, 434 of medium size and width that are configured to extrude material for the exterior sections 412, 414. Two large tooth elements 435, 437, which can be kept closed are positioned at widths corresponding to the hollow sections between the external sections 412, 414 and the central conduit 418. In the center of the print head actuators 442, 444, 445 are sized and positioned to extrude material to create the conduit, consisting of side walls and a hollow middle area.

Optimization of actuator sizes and the use of non-uniform actuator size and spacing is accomplished based on industry and standard build requirements. It is noted that in some embodiments, the print head can include certain locations that have no actuators at all. These sections can include holes (always open) or blocks (always closed) in such locations. This enables a reduction in complexity for actuation drivers and related electronics, saving cost and reducing chance of malfunction in pertinent applications.

### Actuator Control Methods

The present disclosure also provides several methods for directing the movement of the actuators that control the extrusion flow. Linear actuators such as a worm drive hooked to a motor with bidirectional rotation can be used to move teeth with a high level of force from a relatively small motor. Alternatively, a linear system can be implemented using a motor (and potentially gear box) to move through a single portion of a rotation to affect a linear movement of the tooth as in a slider-crank mechanism or equivalent machine design. Another option for actuating the linear movement of the teeth in the z-axis is the use of one or more solenoids per tooth. While the use of a single solenoid provides on/off control, the use of multiple solenoids provides step-wise control of the actuator. An electromagnet with variable current can also be used to achieve a continuous control scheme with a single magnetic coil. Hydraulic or pneumatic control can also be used for linear actuation. While these two techniques are not technically the same, they both enable remote control of the actuator through a hydraulic/pneumatic tube, thus enabling a higher density of actuators in a given control area. The hydraulic/pneumatic actuators provide continuous control of the teeth or lips through variable force/displacement. With pneumatic actuators, which are more focused on providing force, force or position feedback can be added, which could be either direct (e.g. a sensor measuring pressure or position) or indirect (e.g. a camera measuring position of one or more actuators). With a hydraulic system, which is more closely defined by the volume-displacement, the volume can be metered to achieve positional accuracy in the system, potentially in combination with another form of sensing (direct or indirect) similarly to the example of the pneumatic system described above.

In another embodiment, a spring and wire mechanism can be employed in which a spring acts to close and a wire is used to pull open the actuator. This mechanism can also be reversed, for example, if the spring force has a low magnitude such that the spring (or just the extrusion force) opens the actuator and the cable closes the teeth when pulled. Using this technique numerous cables to be operated from a control area such that more actuators can be used to control the smaller control area than otherwise might fit into the space for direct actuation of the actuators.

It is noted that all control systems benefit from having information to provide feedback, fine-tuned control, and ground truth states. For this reason, it is beneficial to provide feedback to all of these actuators to ensure that they are performing the tasks as desired. Toward this end, there are multiple general strategies for providing feedback that can be used in conjunction or independently as needed. In some embodiments, positional sensors can be attached to each actuator and can comprise but are not limited to, linear optical sensors, linear resistive sensor, or rotary sensors (e.g. an encoder or potentiometer). In alternative embodiments, the output of the actuators can be used to measure the movement of the actuator and/or current used. The measurement of current provides a proxy for the force output of a motor, thus enabling a user to build models to better understand and control the movements of the system. A high current surge can indicate that the motor is struggling to move (e.g. it may have reached a stop), while further analysis may provide additional information, such as problems with actuator closing. This information could provide input into other systems, such as temperature control, extrusion drive rate, etc.

In an additional or alternative embodiment, imaging equipment can be used to measure the movement of the actuators. The imaging equipment, such as one or more camera(s), coupled with computer vision algorithms configured for detecting and measuring the location of all of the teeth, can be coupled to the print head, or mounted in a more static position with respect to the 3D printer. The print head and/or teeth could have patterns, textures, or other modifications to allow for faster or more efficient algorithms to be used by the camera's computer vision module. The imaging equipment can also be used to measure additional information, such as any defect or warpage of printed object, and accuracy of the print compared with the digital design. Other sensors, such as lidar or IR cameras that project dot arrays can be used to augment the feedback regarding the printhead, the print and the accuracy of the build.

### Extended Supports and Transfer Roller

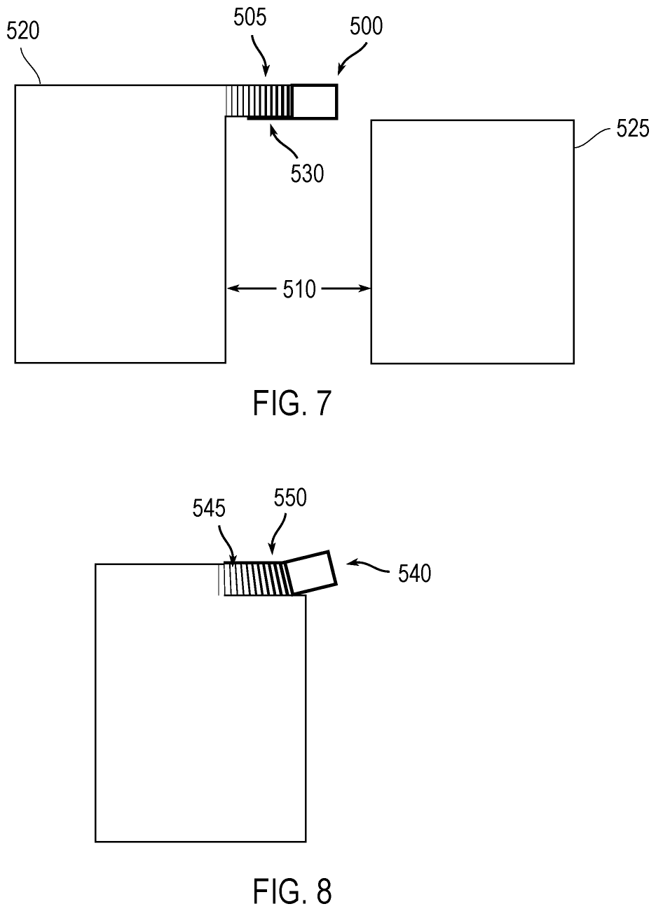

Supports such as extended flaps can be used in the context of the linear extrusion print head systems and methods disclosed herein for a number of purposes in facilitating the construction of parts. In one exemplary application, extended flaps can be used to support extruded material as it cools and/or hardens. FIG. 7 is a schematic illustration of an example printing operation in which the print head 500 is extruding material 505 to span a gap 510 between two cooled and solidified objects 520, 525. A support flap 530 can be folded or pushed or clipped on to support the extruded material as it cools and solidifies. The flap 530 is deployable and retractable and may be actuated via a control mechanism on the print head that is under the control of the software running the print head. Certain materials such as thermoplastics, which harden quickly, are ideal candidates for using such supports in specific conditions like the one shown as the print head can still move quickly while providing temporary support. Other materials with slower cure/hardening times may benefit less from such integrated supports, as waiting for them to harden would slow down the entire print job. However, there may be cases where this was still warranted in a specific build. The flaps can also be used in a variety of other applications.

One such application for a support flap is in building vertical columns that are printed by moving the extrusion head in the z-axis instead of along the x-axis. Using flaps on all sides of the extrusion can provide optimal support in such a process. Alternatively, the support flap also enables the printer to apply pressure to a new layer as it is laid down onto the layer below it, thus enhancing inter-layer bonding. FIG. 8 is a schematic illustration of use of a support flap to promote inter-layer compression. As shown, as a print head 540 extrudes a layer of material 545, a support flap positioned on top of the extruded material applies compressive pressure to extruded material as it cools. In addition to achieving better interlayer bonding, the compressive pressure applied by support flap 550 contributes to minimizing warpage during cooling by providing a stable pressure to constrain any deformation of the material as it cools. In some implementations, the support flap can be made with a very low friction surface (e.g., Teflon) that does not interact with (stick to) the newly extruded (hot or warm) material. For example, a silicon coating or other non-stick surface or any other surface known to achieve low friction and not react with the material being extruded can be used. The surface can also include a lubricant, such as an oil or water when suited to the specific material used. Alternatively, a small amount of solvent can be added to maintain low surface friction as well as prepare the top of the object surface for deposition of the next layer.

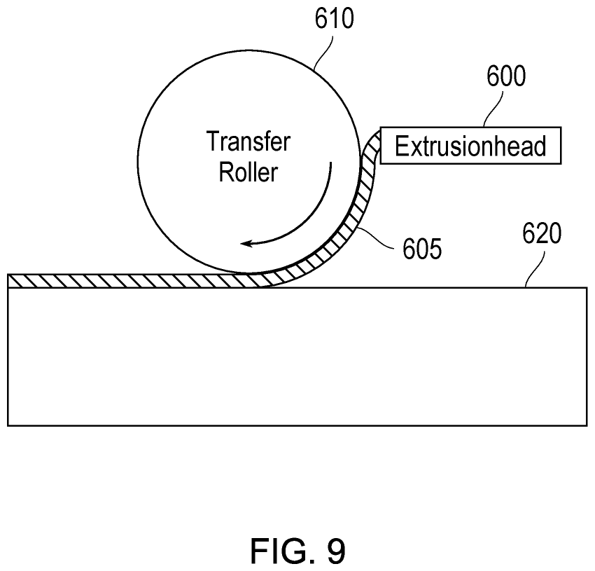

A transfer roller is an example of another useful supplementary device that can be used to facilitate 3D printing with the linear extrusion print head. A transfer roller is used between the print head and the object being built. FIG. 9 is a schematic illustration of the use of a transfer roller with a linear extrusion print head according to the present disclosure. As depicted, as an extrusion head 600 extrudes material 605, the material 605 is applied first to a rotating transfer roller 610 positioned adjacent to the extrusion outlet before being applied as a layer on a built object 620. The transfer roller 610 then deposits the material onto the object through application of pressure and heat. The transfer roller helps promote bonding particularly when using thin layers, as the roller enables a layer to be fully bonded to the layer below before cooling. The improved bonding reduces the likelihood of defects during cooling, especially within a very thin layer.

The transfer roller can be equipped with a spring or an actuation mechanism to apply pressure downwards to facilitate interlayer bonding. Control of the temperature of the surface of the roller can be used to facilitate the attachment of the extruded material from the print head and as well as separation of the attached material from the roller onto the object. For example, the roller can be controlled to be warmer near the extrusion head and cooler as it moves towards the object surface, or vice versa, depending on the material properties. Temperature variation and control can be facilitated by using a thin shelled roller with internal heat and cooling blocks that are static and do not rotate with the outer transfer roller shell, thus facilitating the rapid heating and cooling of the shell by a few or tens of degrees. Additionally, a heat source, or source or radiative heating (e.g. laser, IR, etc.) can be positioned to heat the outer surface of the material and the upper surface of the underlying layer just prior to deposition of the material onto the object surface.

Introduction of a transfer step enables additional modifications to be performed on the layer of extruded material prior to deposition, including removal of or modification of the material (e.g. adding a catalyst, solvent, or other treatment). Additionally, the transfer roller could be used as a method for stacking multiple layers of material from separate extrusion heads in one step. This could be useful for achieving active functions/materials or simply for depositing material faster while maintaining high resolution in the z-axis.

### Systems for Operating Sheet Extrusion Print Head

Embodiments of printing systems according to the present disclosure can be based on a coordinate (Cartesian) movement system, in which the print head is operated to move in the x-axis while it deposits material in the y-axis and shift up along the z-axis with each layer deposited. In one method for print head motion control, the print head is mounted on a gantry frame or carriage with actuation in the x-axis and z-axis (and potentially y-axis). The carriage is typically moved using wheels or pulleys. The y-axis movement is optional depending on the desired build volume vs. the width of the print head (i.e. if the print head's width defines the build volume, no actuation in the y-axis is necessary, while a build volume larger than the width of the print head would require such actuation in a gantry system.) One of the advantages of a gantry system is that it provides relatively simple actuation across a large length (and potentially height. The carriage can be moved across the x-axis for a long distance defined by the size of the frame or support. It is preferable for the height of the frame or support is consistent across the build. One way a gantry system can be implemented is by using a crane from which the print head is suspended. One advantage of this method is that it does not require s installation of a large framework around the entire build volume.

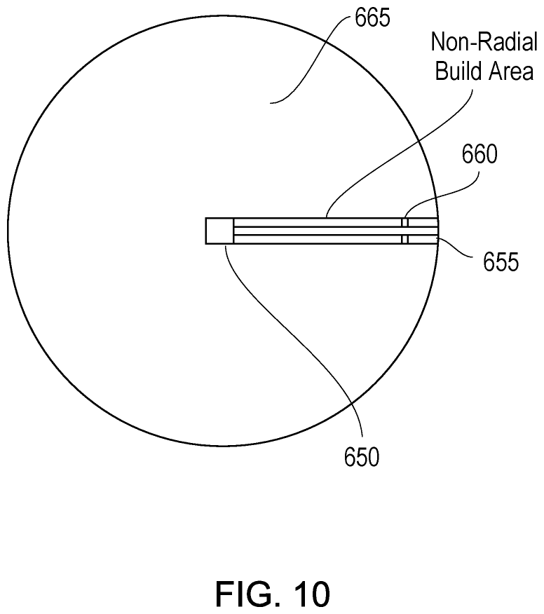

FIG. 10 is a schematic plan view that illustrates a print head movement system that uses a crane comprising a base 650 and a support truss 655 pivotably mounted on the base. A print head carriage 660 is mounted on the support truss 655 and is movable along the extended length of the truss. In this arrangement that print head covers a large radial build area 665 in a radial coordinate system. The z-axis movement can be achieved by the crane base or between the crane support truss and the print head carriage. X-axis movement is enabled by moving the print head along the crane support truss.

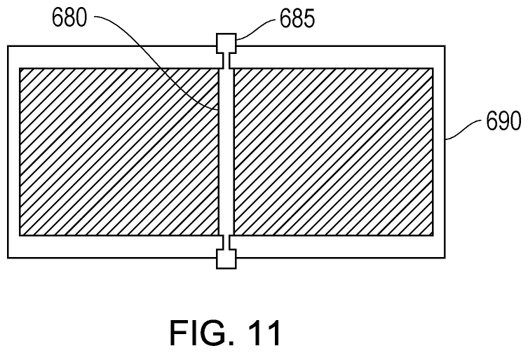

In another arrangement, shown in FIG. 11, a print head carriage 680 is mounted via wheels 685 on a frame 690. The carriage 680 covers the width of the build area. The wheels 685 carry the print head carriage along the x-axis, and either the wheels or the entire frame can extend in the z-axis. The print head carriage can comprise a single print head covering the width of the build area or more print heads actuated in the y-axis along the length of the print head carriage. In some implementations, the x-axis supports can be inside the build area rather than outside of it as shown. Additionally, while a two-side frame is depicted, a single beam can support the print head carriage from one side without support on the other side.

Another technique for controlling the movement of the printer carriage provides a suspension arrangement. In one example implementation, several posts can be installed, for example, four posts at each corner of the build area. Wires or cables are then connected to each of the corners of the print head carriage. The wires are each actuated to control the movement of the print head carriage in all three axes through coordinated adjustment of the cables. Additional supports and cables could be used to enhance stability and control. The number of posts and cables can be varied. Movement with as few as two cables is possible. Typically however, three or more cables are preferred. The print carriage can include active or passive leveling technologies in order to ensure the print head stays level with respect to the build area.

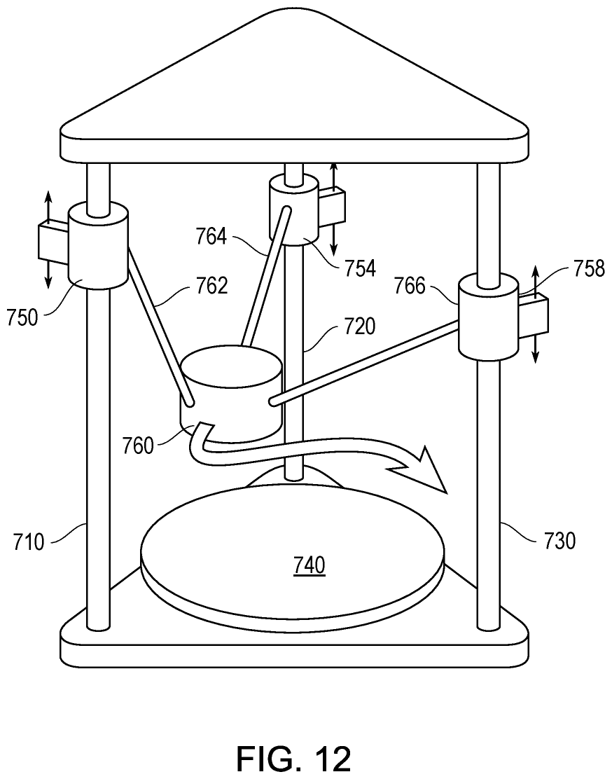

Another embodiment for controlling movement of the printer head involves a delta-based control scheme. An exemplary embodiment a delta-based control arrangement is shown in FIG. 12. Three vertical columns 710, 720, 730 are installed around a build area 740. Vertical carriers 750, 754, 758 are mounted onto respective columns 710, 720, 730 with the ability to move up and down the columns through actuation. The carriers 750, 754 758 are coupled to a print head carriage 760 by fixed-length struts 762, 764, 766 (the struts can be arranged in pairs) via hinge joints. The struts 762-766 constrain the print head 760 from tilting, while the constrained length enables movements of the three vertical carriers to accomplish three-dimensional movement of the print head within the build area.

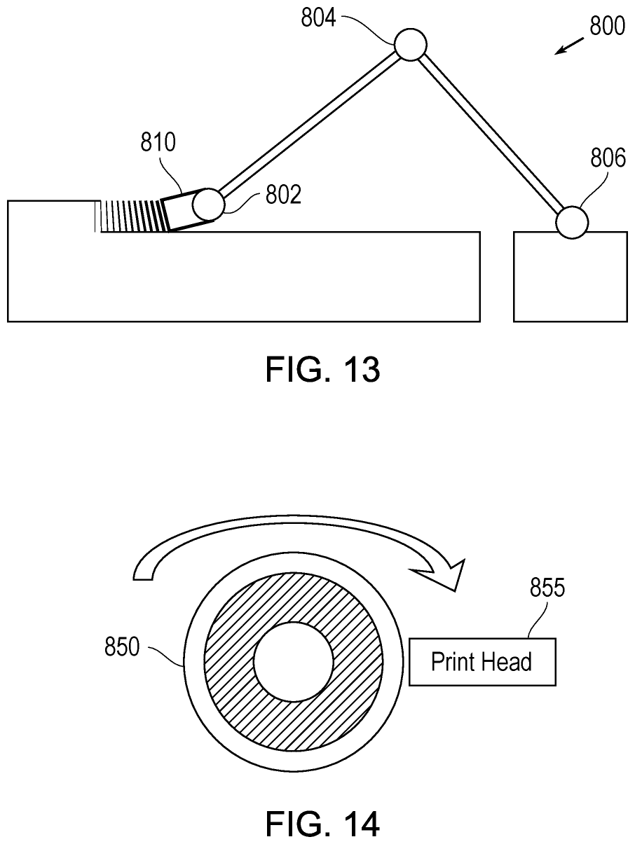

A robotic arm can also be used for moving the print head. Some implementations rely on an arm with three active joints to provide movement in x and z axes. It is noted that the number of degrees of freedom that the robot arm has, which is based on the number of the actuated joints, can vary based on the degree of flexibility required. FIG. 13 is a schematic illustration of a robotic arm 800 for mounting and moving an extrusion print head 810 according to the present disclosure. The robotic arm 800 articulates by means of three joints 802, 804, 806. Additional joints can be included to provide for movement in the y-axis. The robotic arm can be mounted on a carrier to reduce the number of actuated joints. For example, the robotic arm could be mounted on a carrier that moved along the y-axis if movement along that axis is desired. Similarly, the carrier can be mounted on a support aligned with the z-axis for additional build height. The robotic arm can rotate the print head around the z-axis (either at the base or an end effector) for printing along different axes to take advantage of the width of the print head in a different way or accomplish structural reinforcement in the most relevant direction. Additionally, the robotic arm can be mounted on a mobile robot, carrier, or truck. For example, if the printing system is being used to construct a road, the system can be mounted on the back of a truck and the print head can be aligned with the road surface to build the road layer by layer.

In another implementation, the linear extrusion print head is used to print in a rotational manner. FIG. 14 is a schematic illustration showing rotational printing in which a tire 850 is printed layer-by-layer. Rotational printing can be obtained by moving an object in a continuous or discontinuous spiral while the print head 855 extrudes material. In this case, the printer can be used to create complex internal structuring, including multiple materials. For example, an airless tire can be constructed with a solid core for mounting, complex internal structures to provide shock absorption and a thick outer surface to provide wear resistance.

It is noted that the printing system can be configured to enable non-planar build layers, or layers not aligned with the traditional gravity-aligned z-axis. For example, if the build object is cone-shaped, the printer can be configured to print the bottom layers in the traditional axis and to rotate such that the print head extrudes in a non-planar radial coordinate system aligned with the angle of the cone upper surface, thus printing one continuous layer to form the cone. Non-planar prints can be performed using a robotic arm, for example, but can also be performed using other techniques discussed above with additional actuation of the print head. Non-planar printing has the benefit of providing for overhangs of 90+ degrees. While such overhangs can be built using the support flaps described above, it can be advantageous to use non-planar printing.

Furthermore, in some embodiments, instead of driving the print head, the build-bed can be actuated instead. For example, in some setups, the print head remains static while the bed with the object model is moved in both the x- and z-axes. In some cases, the print head can move in one axis while the bed moves along the other.

While in the description above, the print head has generally been aligned to extrude material in the x-axis, the print can be oriented in a number of different ways. In the standard method of extruding the material emerges from the behind print head directly onto a surface below while the print head moves in approximately the opposite direction of the extrusion. In this technique there is a gap between the extruding material and the surface due to the thickness of print head die. In applications in which the gap is problematic, tilted printing can be employed. In tilted printing, the print occurs at a shallow downward angle but primarily in the x-axis. In this technique, the extruded material contacts the layer beneath more directly while the extrusion head can apply some pressure onto the lower layer to promote bonding. When the tilt angle reaches 90 degrees, the extrusion head is pointing downwards. While downward print is helpful in providing pressure for bonding, it minimizes the effectiveness of intralayer structuring in the z-axis. It is suited for printing thin layers.

It is also possible to extrude in front of the print head at an angle by pushing out material ahead of the print head's movement which is then ‘rolled’ onto the layer beneath. This technique can heat surfaces between two layers using a heat source mounted in front of the print head. In some embodiments, the Extrusion Head to accommodate application of material at various angles and on flat, curved, or vertical surfaces. A tiltable print head (around the x-axis, the y-axis, or both). can enable the print head to adapt to various geometries or to build non-planar surfaces more easily. For example, a spiral slide or screw could be built far more efficiently by avoiding the constraints of a cartesian coordinate system. It is noted that with the capability of the print head to tilt, rotate or otherwise change in orientation bidirectional and multi-directional printing is possible with less complex movements of the print head carriage. For example, the ability to either rotate the head around the z-axis 180 degrees or to rotate it around the y-axis by up to 180 degrees provides such capability.

In order to propel material through the print head, one or more extrusion drives are used. Extrusion drives are known in the industry and can be single screw, double screw or any other technology that enables the use of commercially/industrially available pellets or other materials to be extruded through a print head. The extrusion drive generally includes thermal controls (heating and sometimes cooling) to ensure that optimal temperatures are reached when dealing with a temperature-dependent printing material. While pellets are cost-effective starting materials, the print heads disclosed herein can use filaments or other raw materials such as cement mixtures, thermoset resins, clay, or other materials with characteristics suitable to be extruded from the print head. The drive is computer controlled. Those of skill in the art would readily understand that computer-executable code can be used to control the extrusion drive and the actuators of the print head in accordance with a geometric model of a model. The control module for the extrusion drive includes a model that can anticipate future material needs based on upcoming instructions for printing in order to optimize control. The model can be based on data gathered through the use of trial and error, a physical model and/or machine-learning methods. The control module is configured to anticipate events expected to occur in the upcoming interval (generally in the range of 1 second or less, but potentially up to a few seconds for very large systems or those with long material tubes).

To illustrate this via an example, at the end of each pass, the print head either switches direction and continues printing or stops printing and returns to a home position on the x-axis. In the latter case, the control module would stop extruding material for a few seconds while the print head returns to the home position. However, in addition to this planned stop, prior to reaching that command, the control module can slow down the extrusion drive allowing material already moving towards the print head to complete the last extrusion task and reducing the likelihood of extruding excess material that might drip or otherwise be wasted or interfere with the build. This same pre-prediction can be used to accommodate changing volumes of extrusion as various teeth open and close. For example, if 80% of the teeth close, and no change in extrusion speed was made in advance, the material may be forced through the remaining open teeth at a rate greater than desired, thus impacting the build quality. By slowing the extrusion slightly in advance of many teeth closing, the flow can be optimized to continue without fluctuation as the teeth close. Such flow adjustments will aid the accurate extrusion of material and may even include actions such as temporarily reversing the extrusion direction at the end of a run in order to ensure no material is extruded where it is not needed.

In a different configuration, the extrusion drive can use hydraulic or pneumatic pressure to pump material in a relatively liquid state. The control module can control the pressure of the material as it flows through the printing system to the print head and can use vacuum pressure at specific times to quickly stop the flow of material to the head. Pressure sensors or flow sensors can be used to measure and provide feedback for predicting optimal pressure or extrusion drive speed.

The extrusion drive can be, but need not be, separate from the print head. For example, the extrusion drive can be positioned on the print head carriage with pellets or with a tube feeding the pellets. It can be more efficient in some situations to use a tube to transfer melted pellets or other materials to the print head for extrusion. As this can be challenging, there are a number of strategies to prevent system failures due to clogs or unreliable material availability. The tubing path may be controllably heated when using temperature sensitive materials to precisely manage the temperature of material moving through it to within a small tolerance range of one or two degrees. This can be achieved using of thermoelectric heaters and fans and/or heat blocks to enhance stability of the temperature as material moved through the tube. The tubing is flexible or jointed to be able to reach the print head in various locations around the build areas. Cable supports can be used to bend at an appropriate angle above the print head when the print head approaches proximally and to extend when the print head moves distally.

It is preferable that the tubing not expand dramatically under pressure, as such expansion can generate stored potential energy that can make it difficult to optimally control the extrusion drive. It is also preferable for the tubing to be temperature resistant. Various materials meet these characteristics such as metals and plastic material. The tubing has smooth and non-reactive internal surfaces to minimize friction and surface tension or any other type of interaction between the material and the inner surface of the tube. In use cases in which the extruded material contains abrasive materials, the tube can be abrasion resistant or have a liner that is abrasion resistant. The tube can be multilayered, and in some embodiments, multiple tubing paths can be used. An ideal material path/tube may be multilayered or multiple paths may be used in order to achieve the desired functionalities.

One way to clean the tubing is to run clean sand through the extrusion path, which attaches to remaining material and pulls it through the machine. The sand can be slightly abrasive, helping to pull adhering material from internal surfaces of the tube. Other similar particulates can be used such as modified sand, metal particles, or even plastic particles with a higher melting point. The sand materials can be recycled for a number of cleaning operations. Solvents that act on the extruded material without affecting the tubing surface can also be used. In some case high temperature carbonizing step can be added followed by a wash with a solvent or even water to remove the char/carbon. Alternatively, hot fluids that melt adhering materials can be run through the tubing.

### Extrusion Materials

Many different materials can be extruded using the print head systems of the present disclosure. Several materials are described but this description is not intended to be limiting. The primary material used in the disclosed embodiments is thermoplastic. Thermoplastic has many advantages in a variety of industries in terms of ease of handling. It is easy to shape, solidifies rapidly, can be post-processed, is easy to recycle and has a long history of use in additive manufacturing (with accumulated knowledge about properties of thermoplastics). Thermoplastic also has advantageous physical properties, such corrosion-resistance, flexibility, compressive and elastic strength, and low brittleness. Thermoplastics are therefore considered an ideal material for producing a large variety of objects. Higher grades of thermoplastics (e.g. engineering-grade polymers) can have mechanical properties approaching steel, especially when strengthened through fiber reinforcement. However, high quality thermoplastics can be comparatively expensive in comparison to other common build materials (e.g. concrete) and thus their use is intelligently managed in order to minimize waste and optimize for performance and added functionality. Therefore, in additive manufacturing, thermoplastics are often used in ways that add value over designs possible with other manufacturing methods, such as being used to create voids, create complicated internal structures, and for applications that require rapid solidification such as spans, vertical structures, and many self-supporting structures.

One of the ways to make the use of thermoplastics more affordable in large format additive manufacturing is through the use of simpler pellet feedstock. While most thermoplastic 3D printers use filament, some large format 3D printers use pellets which typically cost significantly less than the same volume/weight of filament. Pellets are a raw material that is available at both commercial and industrial scales. In a 3D printing system, pellets are placed in a hopper upstream of the extrusion drive and print head. The extrusion drive can comprise screws and heaters that compress, heat, and mix the pellets as they melt. As noted above, the pellets can also be melted beforehand and driven towards extrusion with hydraulic or pneumatic pressure. Thermoplastics can be reinforced with fiber for increased strength and some pellets can include fiber elements in the raw material. Care can be taken to align the fibers in the extrusion drive before deposition as this can increase the strength of the material in a desired direction.

Fillers can also be added to reduce material costs as suitable. The filler materials can include various grades of polymers, fiber materials, sand or other particulates. In compressive load bearing applications, sand-thermoplastic mixtures have similar properties to pure thermoplastics. The additional filler materials can be added by a dosing mechanism to ensure accurate results. For example, in printers with an extrusion screw, a dose of filler material can be added at one of the ends of the screw. When liquid thermoplastic is used, the filler material can be added in a liquid tank or flow channel. When combined with the forward planning and drive control, it is possible to print finely tailored mixtures of sand/polymer based on the specific requirements of a given layer or section of layer even at a voxel-by-voxel level.

Furthermore, dyes, pigments or other active materials can be added to the extrusion material mix to achieve specific effects, such as coloring agents, flame retardants and plasticizers. In this application particularly, forward planning and strategic metering of various potentially additives can realize a high level of control at the output of the print head. Titanium dioxide additives can generate surfaces with self-cleaning properties, copper particles, graphite/graphene, silver or similar particles can modify the electrical properties and thermal conductivity at specific areas or layers of a printed object. For such additives, a print head can be equipped with multiple channels and a mixing mechanism each leading to a controlled output. The particulate injection can be pressurized and employ a carrier of the same polymer being extruded to facilitate easier mixing and dosing. Other materials that can be used include cement (with fiber reinforcement), thermoset plastics, clay, or any other extrudable material. Reactive extrusion can also be used in which a 2-part thermoset can also be mixed in the head and extruded

### Synergistic Systems

The above-described systems can be coordinated together in manufacturing ecosystems. This is the vision of the current Industrial Revolution 4.0 in which breakthrough technologies participate in automated manufacturing and have a synergistic effect by enabling new processes, systems, and collaborative possibilities via intelligent coordination of multiple agents. A combined system can include multiple print heads that communicate and collaborate with each other. The print heads can work along different positions, for example different x-axes separated along the y-axis which enables faster printing of larger structures/objects without the need for a larger print head or for the printheads to move in the y-axis. In another implementation, multiple print heads can be rotated to print along the y-axis, enabling faster and more accurate structuring. In embodiments in which the printers extrude using aligned fibers (e.g., continuous or internal alignment of fiber-reinforced thermoplastic via internal channels) alternating layers can have fibers aligned in different directions, creating a more uniform strength profile. It should be noted that the ratio of perpendicular printing need not be 1 to 1, as printing in one direction can be the primary build process while another printing can be supplementary and dedicated to only specific sections of the print.

In some collaborative printing projects, different print heads can be allocated different materials. In such printings, printers can extrude relevant materials in sections while others remain idle or work elsewhere. In other cases, printers can print multiple different materials in the same layer as the print heads can be rotated to extrude downwards. The resolution in the x- and y-axis can remain high in this mode. Print heads that print with different z-axis thicknesses can be used in a given project. For example, the inner structure of an object, not noticeable externally, can be printed with high print head widths at high speeds and low resolution, while a narrower print head can print the outer surface with a higher resolution to be more visually appealing. If the internal and external sections are distinguished by being primarily on different z-axes, the printing speed can be faster without sacrificing resolution through the use of two print heads, one with lower resolution and higher z-axis thickness and another with higher resolution and lower z-axis thickness. There can also be a benefit to having a print head allocated to extruding at a higher temperature, for example, to aid in inter-layer bonding, or to extrude a high temperature material. The benefits from using multiple print heads to print in different and synergistic ways (materials, thicknesses, temperatures, alignments, etc.) can thereby be used to increase inter-layer lamination, achieve enhanced (or reduced) flexibility, provide insulation (electrical, thermal, acoustic), to achieve explosion or bullet resistance, or to achieve any other object-level properties enabled by these printing capabilities. The activities of multiple printheads can be performed in series or in parallel, or a combination thereof.

As noted, the ability to interchange and adapt different print head increases the flexibility of these print heads to print a variety of complex geometries. For example, if a house is being built, different print heads can be adapted for each section or material type. While printing a floor may require only square teeth actuators, it might be more suitable to used curved teeth actuators for printing an archway or ceiling. Similarly, specially-designed teeth can be adapted for building pipe systems/conduits. By having the print heads reconfigurable and interchangeable a set of robotically mounted 3D print heads can be arranged to move around a job site performing various tasks and then to change print heads as needed when a replacement is need for the next task queued for that system. Task coordination software can be used to plan, coordinate and actively update multi-agent builds.

In order to coordinate multiple agents in a given work area, localized positioning systems (LPS) are advantageous. There are several methods for positional tracking that can be used to guide the position of a single print head or multiple print heads in a job site or printing area to enhance accuracy, or to coordinate movement and ensure alignment of activities. In wireless tracking, similar to GPS, the distance between the print heads and multiple transmitters is determined and the coordinate position of each is determined by triangulation. This technique is particularly suited for comparatively large site areas but can be used in smaller areas with used as part of a solution (see Sensor Fusion). Another technique, inside-out optical tracking, uses cameras mounted on tracked devices (e.g., print heads or other collaborating system) which observe the surrounding to determine local positions. The tracking can be aided with tags and other visible landmarks to map the area, in some cases such modifications are not necessary and computer vision and SLAM methods can be employed to determine relative positions. In a complementary technique, outside-in tracking, features on the print heads, robot arms, etc. are tracked by cameras or optical sensors mounted in the environment. Optical tracking can be based on non-laser visible light, lasers tracking such as LIDAR, as well as the use of IR or other wavelengths of light.

Inertial tracking relies on the use of IMUs or similar to measure accelerations in a device and integrate to determine the location of the device. This method of tracking is extremely prone to drift due to the double integration, but is very cheap to implement and fast to get data. It is an excellent complement to a non-drifting solution. Acoustic tracking is accomplished by using triangulation with sound waves. It can involve putting emitters in the environment and receivers on the device or vice versa. Generally, at least four emitters (or detectors) are used to accurately determine the location of a detector (or emitter). The system can rely on time of flight measurements or phase offsets to determine the distance that an object is from each anchor point, which serves to triangulate the position. To reduce the effects of sound wave reflection, multiple detectors can be embedded around the environment in known positions (e.g. 10 or more) with each mobile system employing and emitter with a different frequency, enabling conflicting data to be resolved to more accurately determine the position of a print head or supporting mobile system. Magnetic tracking is an additional technique, which is best suited as a supplementary tracking method. In this technique, induction of positionally constant, highly differentiated magnetic fields in the environment is detected.

Sensor fusion is helpful in overcoming any weaknesses of any particular tracking method and in ensuring an accurate, wide-area LPS. While some of the tracking techniques, especially optical tracking, can accurately determine position performing alone, all of the techniques benefit from working in concert with other methods. For example, a printing system can be equipped with an inertial tracking system for fast-frequency updates (as the data is easier to process) and an optical or other similar system can be used to maintain ground truth and provide corrections to the data coming from the inertial system.

In addition to tracking, computer vision systems can be used to detect defects, perform progress updates, and in other applications useful to the user of the printing system. For example, a computer vision system can be configured to detect defects and to control equipment (e.g. a print head or robot arm) to fix the defect. The changes can be tracked and used to enhance future prints through machine learning, and further evaluated to ensure that such changes do not have a negative impact on functionality.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure or the invention described herein. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1-35. (canceled)

36. A method of building a wall structure using a 3-D print head including an extrusion outlet with a width and a height, and a plurality of actuators of varied widths configurable to selectively open or block portions of the width of the extrusion outlet, the method comprising:
configuring first and second actuators, positioned at respective first and second ends of the width of the extrusion outlet, to be in an open state so as to produce exterior wall sections of the wall structure when material is extruded through the outlet in a first extrusion pass;
configuring a third actuator adjacent to the first actuator, and a fourth actuator adjacent to the second actuator, to block portions of the width of the extrusion outlet, so as to create hollow sections next to the exterior wall sections during the first extrusion pass; and
configurating a fifth actuator adjacent to the third actuator and a sixth actuator adjacent to the fourth actuator to be in an open state so as to produce walls of a central conduit during the first extrusion pass.

37. The method of claim 36, further comprising:
configuring the third and fourth actuators into an open state during a second extrusion pass so as to produce support sections that extend between the exterior wall section and the walls of the central conduit.

38. The method of claim 37, further comprising sequentially opening and closing the third and fourth actuators during successive extrusion passes to create evenly spaced supports throughout the hollow sections of the wall structure.

39. The method of claim 36, further comprising configuring a seventh actuator, positioned between the fifth and sixth actuators, to block a central portion of the width of the extrusion outlet and thereby create a hollow passage between the walls of the central conduit.

40. A method of building a wall structure using a 3-D print head including an extrusion outlet with a width and a height, and a plurality of actuators of varied widths configurable to selectively open or block portions of the width of the extrusion outlet, the method comprising:
configuring first and second actuators positioned at respective first and second ends of the width of the extrusion outlet to be in an open state so as to produce exterior wall sections of the wall structure when material is extruded through the outlet in a first extrusion pass;
configuring a third actuator adjacent to the first actuator and a fourth actuator adjacent to block portions of the width of the extrusion outlet, so as to create hollow sections next to the exterior wall sections during the first extrusion pass; and
providing a first opening positioned adjacent to the third actuator and a second opening positioned adjacent to the fourth actuator so as to allow material to pass through the extrusion let and produce walls of a central conduit during the first extrusion pass.

41. The method of claim 40, providing a blocking element positioned between the first and second openings to block a central portion of the width of the extrusion outlet and thereby create a hollow passage between the walls of the central conduit.

42. An apparatus for three-dimensional (3D) printing of a wall structure comprising:
a print head having:
at least one inlet for receiving material to be extruded;
an extrusion outlet having a width and height, the print head being configured, when the outlet is completely unblocked, to extrude a sheet of material of the width and height of the outlet; and
a plurality of actuators, including first, second, third, fourth, fifth and sixth actuators positioned at different points along the width of the print head and arranged to controllably block one or more sections along the width of the outlet in such a manner as to prevent material from being extruded through the blocked one or more sections, thus enabling selective extrusion of material through a remainder of sections of the outlet that are not blocked in order to selectively print a width of an entire layer of the object in a single pass; and
wherein, to print the wall structure:
the first and second actuators, positioned at respective first and second ends of the width of the extrusion outlet, are configured to be in an open state so as to produce exterior wall sections of the wall structure when material is extruded through the outlet in a first extrusion pass,
the third actuator adjacent to the first actuator, and a fourth actuator adjacent to the second actuator, are configured to block portions of the width of the extrusion outlet, so as to create hollow sections next to the exterior wall sections during the first extrusion pass, and
the fifth actuator, which is adjacent to the third actuator, and the sixth actuator which is adjacent to the fourth actuator, are configured to be in an open state so as to produce walls of a central conduit during the first extrusion pass.

43. The apparatus of claim 42, wherein the third and fourth actuators are re-configured into an open state during a second extrusion pass so as to produce support sections that extend between the exterior wall section and the walls of the central conduit.

44. The apparatus of claim 42, wherein the third and fourth actuators are configured to sequentially open and close to create evenly spaced supports throughout the hollow sections of the wall structure during successive extrusion passes.

45. The apparatus of claim 42, further comprising a seventh actuator, positioned between the fifth and sixth actuators, which is configured to block a central portion of the width of the extrusion outlet and thereby create a hollow passage between the walls of the central conduit.
